(19) United States
(12) Patent Application Publication
(10) Pub. No.: US 2025/0085830 A1
(43) Pub. Date: Mar. 13, 2025

(54) INFORMATION PROCESSING APPARATUS, INFORMATION PROCESSING METHOD AND NON-TRANSITORY COMPUTER READABLE MEDIUM

(71) Applicant: JVCKENWOOD Corporation, Yokohama-shi (JP)

(72) Inventors: Tomotaro KOIWA, Yokohama-shi (JP); Kotomi Mochizuki, Yokohama-shi (JP)

(21) Appl. No.: 18/802,259

(22) Filed: Aug. 13, 2024

(30) Foreign Application Priority Data
Sep. 13, 2023 (JP) 2023-148489

(51) Int. Cl. G06F 3/04817; G06F 3/04845; G06F 3/16; G06T 11/00; G10L 13/04; H04L 12/18

(52) U.S. Cl. CPC G06F 3/04817; G06F 3/04845; G06F 3/167; G06T 11/00; G10L 13/04; H04L 12/1831; G06T 2200/24

(57) ABSTRACT

To complement a sharing sense of a meeting scene in an online meeting using a plurality of terminal apparatuses connected through a network. An information processing apparatus according to the present embodiment includes a display control unit configured to display, in an online meeting in which a plurality of users participate by using a plurality of user terminals connected through a network, an icon display area in each of the user terminals, the icon display area displaying a list of an icon of each of the users, and a virtual image generation unit configured to display a virtual image on an icon of at least one of the plurality of users, the virtual image being in common in each of the user terminals.

### CROSS REFERENCE TO RELATED APPLICATION

This application is based upon and claims the benefit of priority from Japanese patent application No. 2023-148489, filed on Sep. 13, 2023, the disclosure of which is incorporated herein in its entirety by reference.

### BACKGROUND

The present disclosure relates to an information processing apparatus and a program.

A web meeting system which can conduct a meeting or the like with a partner in a remote location through a network has been widely known. Japanese Unexamined Patent Application Publication No. 2022-83548 (Patent Literature 1) discloses a technique of, in a web meeting system, confirming facial expressions and the like of other users, understanding reactions to a content of speech, and smoothly performing communication in the web meeting, without displaying a camera image. In Patent Literature 1, a person is recognized from a video acquired with a camera, and an icon reflecting an analysis result of analyzing a motion or facial expression of the recognized person is generated and is transmitted to other terminals.

### SUMMARY

A problem with Patent Literature 1 is that although reactions of participants in a web meeting can be understood without displaying a camera video, there is no event that can be commonly recognized by the participants, and it is difficult to synchronize and tune feelings of the participants.

An information processing apparatus according to one aspect includes: a display control unit configured to display, in an online meeting in which a plurality of users participate by using a plurality of user terminals connected through a network, an icon display area in each of the user terminals, the icon display area displaying a list of an icon of each of the users; and a virtual image generation unit configured to display a virtual image on an icon of at least one of the plurality of users, the virtual image being in common in each of the user terminals.

An information processing method according to one aspect causes a computer to perform: a processing of displaying, in an online meeting in which a plurality of users participate by using a plurality of user terminals connected through a network, an icon display area in each of the user terminals, the icon display area displaying a list of an icon of each of the users; and a processing of displaying a virtual image on an icon of at least one of the plurality of users, the virtual image being in common in each of the user terminals.

A program according to one aspect causes a computer to perform: a processing of displaying, in an online meeting in which a plurality of users participate by using a plurality of user terminals connected through a network, an icon display area in each of the user terminals, the icon display area displaying a list of an icon of each of the users; and a processing of displaying a virtual image on an icon of at least one of the plurality of users, the virtual image being in common in each of the user terminals.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram showing a schematic configuration of an online meeting system according to an embodiment;

FIG. 2 is a diagram showing a configuration of a user terminal of FIG. 1;

FIG. 3 is a diagram showing a configuration of a server of FIG. 1;

FIG. 4 is a diagram showing an example of a display screen in the user terminal;

FIG. 5 is a diagram showing an example of the display screen in the user terminal;

FIG. 6 is a diagram showing an example of the display screen in the user terminal;

FIG. 7 is a diagram showing an example of the display screen in the user terminal;

FIG. 8 is a diagram showing an example of the display screen in the user terminal; and

FIG. 9 is a diagram showing a flow of an information processing method by the online meeting system according to the embodiment.

### DETAILED DESCRIPTION

Hereinafter, with reference to the drawings, an information processing apparatus and an information processing method according to an embodiment of the present disclosure will be described. However, the present disclosure is not limited to the following embodiment. In addition, the descriptions and the drawings below are appropriately simplified to make the explanations clear.

Telework has become widely generalized, and an online meeting with a partner in a remote location has been commonly conducted. In work and meetings conducted in multiple places at the same time, although faces of each other can be seen through a screen, there is an issue of a poor sense of scene sharing because participants are not in the same space. Thus, the present inventors devised the following disclosure for the purpose of complementing sharing senses in a meeting scene of a plurality of users, in an online meeting. When a plurality of users participate in an online meeting, each participant may participate from different places or some participants may participate from the same place.

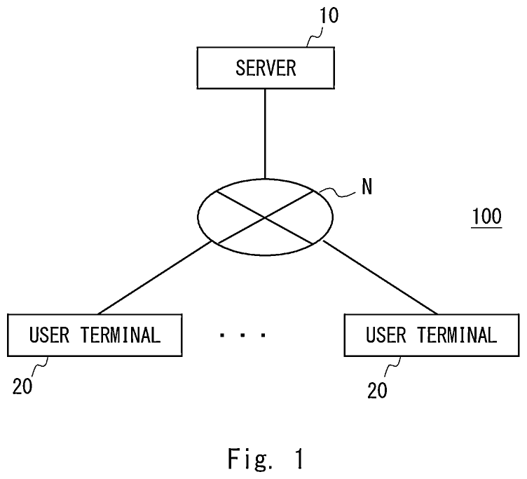

FIG. 1 is a diagram showing a schematic configuration of an online meeting system 100 according to an embodiment. As illustrated in FIG. 1, the online meeting system 100 includes a server 10 and a plurality of user terminals 20. The server 10 and the plurality of user terminals 20 are configured such that data can be communicated with each other through a network N.

In this regard, the network N is a wired or wireless communication line, and is for example, the Internet. However, the communication line is not limited to the Internet, and it may be a combination of the Internet and other communication lines, or a communication line other than the Internet. For example, wireless communication or wired communication such as 4G (Generation), 5G, local 5G, Wi-Fi (registered trademark), or Long Term Evolution (LTE) may be used as the communication method. The communication method is not limited to these examples.

The server 10 has plug-in-software for realizing an event distribution function, in addition to application software for realizing an online meeting function. The user terminal 20 can hold a web meeting as a host by, for example, accessing the server 10 and using the online meeting function provided by the server 10. In addition, the user terminal 20 which is the host can let other user terminals 20 participate in the online meeting as guests by using user information (an ID, a password, and the like).

During an online meeting, the server 10 can use the event distribution function to cause an event to occur at the same time in each user terminal 20 of each user participating in the online meeting. With this event, sharing senses of a meeting scene can be complemented, and a lively discussion can be encouraged. In addition, by use of this event at the beginning of the meeting, an effect of introduction communication (so-called icebreaking) can be exerted. This event will be described in detail later.

As an example, at the time of setting an online meeting, a host user can utilize the event distribution function of the server 10 to create a channel for event distribution. The server 10 may link the online meeting and the channel for event distribution set by the host, and send an invitation email of the online meeting to the user terminal 20 of a guest user. By reproducing a video and a sound based on a common parameter as an event in the user terminals 20 of all users participating in the online meeting, feelings of the users can be synchronized and tuned.

The invitation email may include, for example, an URL for participating in the event besides an URL and a password for participating in the online meeting. The guest user may select whether to participate in the event when participating in the online meeting. That is to say, a plurality of users who will be the guests may include a mix of people who participate in the online meeting in which the event does not occur and people who participate in the online meeting in which the event occurs.

### <User Terminal>

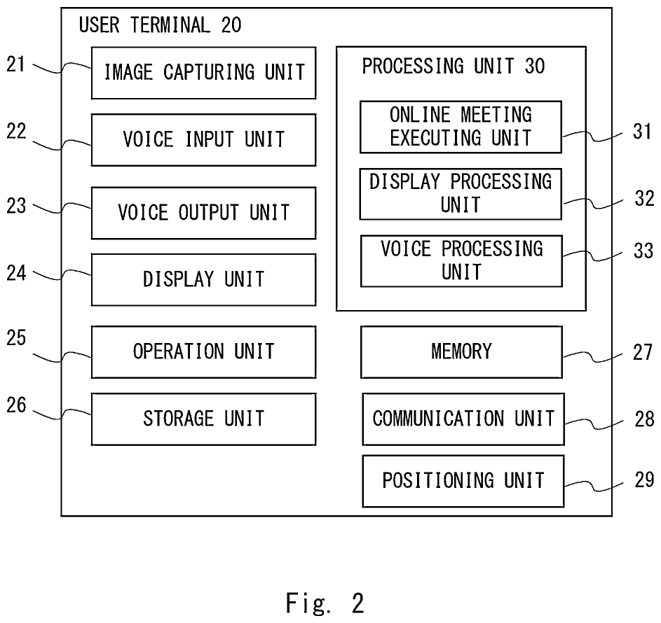

The user terminal 20 is information terminal which is used by a user participating in the online meeting, for performing transmission and reception of data with the server 10 through the network N. The user terminal 20 is, for example, a personal computer, a tablet, a smartphone, or the like. FIG. 2 is a block diagram showing a configuration of the user terminal 20 in FIG. 1.

As illustrated in FIG. 2, the user terminal 20 includes an image capturing unit 21, a voice input unit 22, a voice output unit 23, a display unit 24, an operation unit 25, a storage unit 26, a memory 27, a communication unit 28, a positioning unit 29, and a processing unit 30.

The image capturing unit 21 is a camera that is incorporated in a frame of the user terminal 20, or is externally attached as a separate body in an optional position. The image capturing unit 21 captures an image of a face of a user participating in the online meeting. For example, a Complementary Metal Oxide Semiconductor (CMOS) image sensor or the like may be used as the image capturing unit 21. The image capturing unit 21 outputs, to the processing unit 30, a video signal in which an image of a user is captured.

The voice input unit 22 is a microphone which collects the sound of a voice uttered by a user, and converts this into a voice signal for output to the processing unit 30. The voice output unit 23 is a speaker, headphones, or the like which outputs various voices. The voice output unit 23 outputs, for example, a voice uttered by other users transmitted from other user terminals 20 participating in the online meeting. In addition, the voice output unit 23 can output an event sound generated using the event distribution function. The voice input unit 22 and the voice output unit 23 may be incorporated in the user terminal 20, or may be externally attached to the user terminal 20.

The display unit 24 is a liquid crystal display, an organic EL display, or the like. The display unit 24 performs a display based on the video signal input from the processing unit 30. The operation unit 25 includes a mouse and a keyboard. The operation unit 25 accepts an operation of a user, and outputs an operation signal based on the operation content to the processing unit 30. A touch panel in which the functions of the display unit 24 and the operation unit 25 are integrated may be used. A user can perform an operation by a touch to the touch panel.

The storage unit 26 is an example of a storage apparatus including a nonvolatile memory such as a flash memory or a Solid State Drive (SSD). The storage unit 26 stores therein various programs for realizing the online meeting and the event distribution. The memory 27 is a volatile storage apparatus such as a Random Access Memory (RAM), and is a storage area for temporarily holding information at the time of operations of the processing unit 30.

The communication unit 28 is a communication interface with the network N. The communication unit 28 may establish connection of short-distance wireless communication, and perform communication. In this regard, various standards such as Bluetooth (registered trademark), Bluetooth Low Energy (BLE), Ultra-Wide Band (UWB), and the like can be applied to the short-distance wireless communication.

The positioning unit 29 can use a satellite positioning system such as a Real Time Kinematic (RTK)-Global Navigation Satellite System (GNSS) to acquire position information of the user terminal 20, time information when the position information is acquired, and the like. The positioning unit 29 includes, for example, a positioning means such as a positioning antenna. The position information and the time information when the position information is acquired may also be simply referred to as “positioning information”. The positioning information is, for example, linked to a user terminal ID of each user terminal 20, and is transmitted to the server 10. The acquisition method of the position information is not limited to the above-described method. For example, the positioning unit 29 may acquire the position information of the user terminal 20 based on information on an access point of a wireless LAN or information on a base station. In the addition, the positioning unit 29 may acquire the position information by using a publicly-known positioning system using a beacon transmitter.

The processing unit 30 includes an online meeting executing unit 31, a display processing unit 32, and a voice processing unit 33. The online meeting executing unit 31 can, for example, execute an application program that is installed in advance, access the server 10 for online meetings, and execute an online meeting.

The online meeting executing unit 31 encodes the video signal input from the image capturing unit 21 and the voice signal input from the voice input unit 22, and transmits the encoded video/voice signal to the server 10 through the communication unit 28. If screen sharing of the display unit 24 of the user terminal 20 is in execution, the online meeting executing unit 31 encodes a video signal of an image that is the target of screen sharing, and transmits this to the server 10.

If the image capturing unit 21 is not installed in the user terminal 20, or the image capturing unit 21 is turned off and is not the source of screen sharing, the online meeting executing unit 31 does not transmit a video signal to the server 10. In addition, if the voice input unit 22 is muted, the online meeting executing unit 31 does not transmit a voice signal to the server 10.

The display processing unit 32 decodes the video signal received from other user terminals 20 through the server 10. The display processing unit 32 assembles the video signal received from each user terminal 20 in a predetermined screen format, for display in the display unit 24.

If screen sharing is not in execution, the display unit 24 of the user terminal 20 displays a list of icons of a plurality of users participating in the online meeting. For example, the display unit 24 can arrange and display the icons of all the users participating in the online meeting in a grid shape, on the whole display screen. An area in which the icons of the users are arranged and displayed is referred to as an icon display area. Such a display format is called a gallery view.

If the received video signal is a real-time moving image of other users during the online meeting, the display processing unit 32 displays the moving image as the icon. If a video signal is not received from other user terminals 20, the display processing unit 32 can display, for example, initials of a user of each user terminal 20, a photograph that is set beforehand, or the like on the display unit 24 as the icon.

In addition, if screen sharing is in execution, the display unit 24 of each user terminal 20 can display, on one display screen, an image that is the target of screen sharing and the list of the icons of other users. An area displaying the image which is the target of screen sharing is referred to as a main display area. In this case, one display screen includes the main display area and the icon display area.

Furthermore, when receiving a virtual image signal that is generated using the event distribution function from the server 10, the display processing unit 32 displays a virtual image on the display unit 24 in such a manner that the virtual image is superimposed on at least either of the icon display area and the main display area. The virtual image generated using the event distribution function will be described in detail later.

The voice processing unit 33 decodes the voice signal relating to a content of speech of other users, which is received from other user terminals 20 through the server 10. The voice processing unit 33 synthesizes at least one voice signal received from at least one other user terminal 20, for output by the voice output unit 23. In addition, when receiving an event sound signal that is generated using the event distribution function from the server 10, the voice processing unit 33 synthesizes the event sound signal for output by the voice output unit 23.

### <Server>

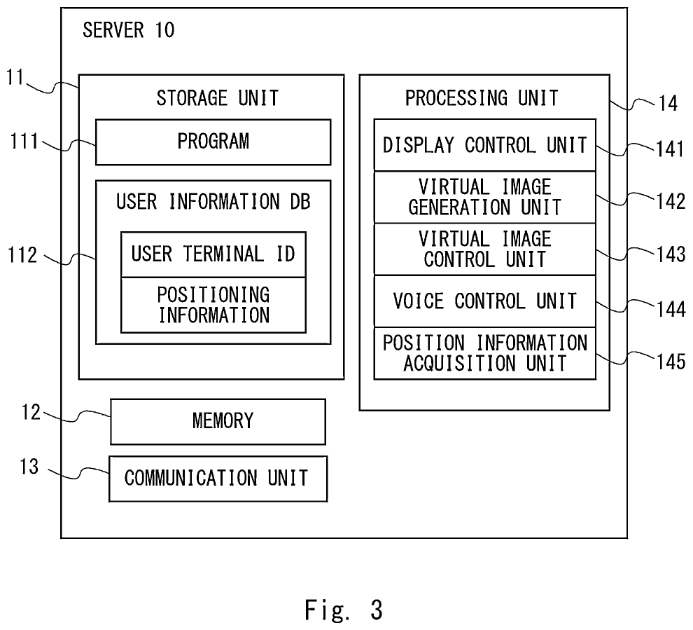

The server 10 is an information processing apparatus for realizing the online meeting function and the event distribution function. The server 10 may be constituted of a plurality of servers, and each functional block may be realized by a plurality of computers. FIG. 3 is a block diagram showing a configuration of the server 10 in FIG. 1. The server 10 includes a storage unit 11, a memory 12, a communication unit 13, and a processing unit 14.

The storage unit 11 is an example of a storage apparatus such as a hard disk, a flash memory, or the like. The storage unit 11 stores therein a program 111 and a user information DB 112. The program 111 is a computer program in which a part of the online meeting function and the event distribution function or the like is implemented. The user information DB 112 is a database which links position information of the user terminal 20 used by each user participating in the online meeting with the user terminal ID, and manages the position information.

The memory 12 is a volatile storage apparatus such as RAM, and is a storage area for temporarily holding information at the time of operations of the processing unit 14. The communication unit 13 is a communication interface with the network N. The processing unit 14 is a processor which controls each configuration of the server 10. The processing unit 14 causes the memory 12 to read the program 111 from the storage unit 11, and executes the program 111. In this manner, the processing unit 14 realizes functions of a display control unit 141, a virtual image generation unit 142, a virtual image control unit 143, a voice control unit 144, and a position information acquisition unit 145.

The display control unit 141 receives a video signal captured by a plurality of the user terminals 20, generates a list display signal for arranging and displaying an icon of each user in the icon display area of each user terminal 20, and transmits the list display signal to each user terminal 20. The icon display area is, for example, an area in which moving images obtained by capturing an image of each user are aligned as icons of a plurality of users participating in the online meeting. The icon display area may include an icon generated for the user terminal 20 not transmitting a video signal, the icon consisting of initials of a user of the user terminal 20 or a photograph that is set in advance.

The virtual image generation unit 142 generates a virtual image signal for displaying a virtual image on an icon of at least one of a plurality of users, the virtual image being in common in each user terminal 20. The virtual image may be, for example, a virtual object image. The virtual object image shows, for example, an animal such as a cat, a dog, or a bird, an insect, a character of a game, an animation, or the like, a natural phenomenon, or a weather phenomenon.

In addition, the virtual object image may be an object recognized from a content of utterances of a user participating in the online meeting. The server 10 may further include a voice recognition unit which acquires voice data of the user, and specifies a topic included in a content of speech with a publicly-known voice recognition technique.

For example, if a content of utterances of at least one user has a word relating to “in-car equipment”, the virtual object image can be an image of an “automobile”. In addition, if a content of utterances of at least one user has a word relating to “sport”, the virtual object image can be an image of a “ball”.

The virtual object image can be registered by each user beforehand. A plurality of the virtual object images registered by each user may be stored on a database not illustrated. For example, any one of a plurality of users can select an optional virtual object image from the plurality of registered virtual object images.

A plurality of the virtual object images, the virtual object images being the same or different, may be displayed on the display screen. In addition, the plurality of the virtual object images may be each displayed on icons of a plurality of different users. A place in which the virtual image occurs may be randomly decided, or may be set by a host user in advance, for example. In addition, the virtual object images may be randomly changed in accordance with a passage of time, or the virtual object images may move within the display screen. For example, in the case of the virtual object image of a “cat”, the “cat” can walk from one end to the other end of the display screen, or relax in a corner of the display screen, in accordance with a passage of time.

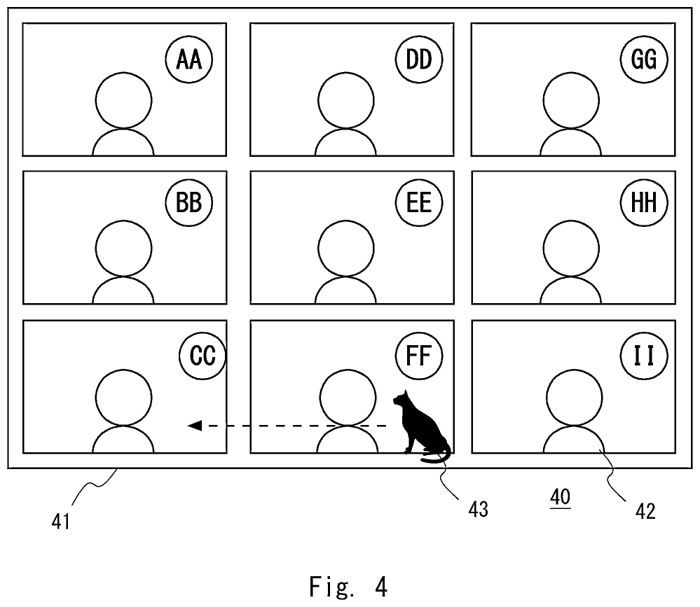

In this regard, with reference to FIG. 4, an example of a display screen 40 to be displayed on the display unit 24 of the user terminal 20 will be described. In the example illustrated in FIG. 4, it is assumed that nine users each indicated by initials AA to II participate in an online meeting. In this case, the nine users each visually recognize the same display screen 40.

As illustrated in FIG. 4, the whole display screen 40 is an icon display area 41. In the icon display area 41, nine icons 42 are aligned in a 3×3 matrix. In this example, the icons 42 are moving images of each of the nine users participating in the online meeting.

On an icon of the user FF, a virtual object image 43 of a “cat” generated by the virtual image generation unit 142 is superimposed and displayed. The virtual object image 43 of the “cat” is displayed on the icon of the user FF in every display unit 24 of each user terminal 20 of the nine users. In this manner, by allowing the nine participants to recognize the same event occurring at the same time, an effect of synchronizing and tuning feelings in an online meeting held in a distant place can be obtained.

The virtual image control unit 143 can move the virtual object image 43 from above an icon 42 on which the virtual object image 43 is displayed, onto a different icon 42 in accordance with an operation of the operation unit 25 of the user terminal 20 by at least one of a plurality of users. The virtual object image can move in the same manner in each display unit 24 of a plurality of the user terminals 20. In this regard, “move in the same manner” in each user terminal 20 includes, for example, a moving speed and a moving aspect of the virtual object image being the same.

For example, any one of the nine users uses a mouse provided for its user terminal 20 to perform an operation of dragging and dropping the virtual object image 43 of the “cat” from the user FF to the user CC, as illustrated with an arrow of a broken line in FIG. 4. In accordance with this operation, the virtual image control unit 143 can move the virtual object image 43 of the “cat” from above the icon 42 of the user FF onto the icon 42 of the user CC. The virtual image control unit 143 may change a moving speed of the virtual object image in accordance with an operation speed of the virtual object image. For example, in accordance with an operation speed of the mouse, the virtual image control unit 143 may cause the virtual object image 43 of the “cat” to move onto an intended icon by walking or running. In each user terminal 20, the moving aspect including, for example, a gait, a moving speed, and a stopped state before and after a movement of the “cat” may be the same.

In addition, for example, a user with no virtual object image being displayed on its icon can move an object image onto its icon by clicking the virtual object image. The object image may move in a natural motion in accordance with a type of the object. For example, the virtual object image of the “cat” may move between icons by walking. In addition, the virtual object image of a “bird” can move between icons by flying. When moving the virtual object image by an operation of a user, a priority of moving the virtual object image may be set for each user. For example, a priority of a user having an icon in which the virtual object image is displayed can be made higher than a priority of a user having other icons.

Furthermore, the virtual image control unit 143 may specify a speaker of the online meeting, a person having a large amount of utterances, and a person having a little amount of utterances, and may move the virtual object image. For example, the virtual image control unit 143 can move the virtual object image onto the icon of the person having the large amount of utterances, thereby attracting attention of other users to the person who is uttering. In addition, the virtual image control unit 143 may move the virtual object image onto the icon of the person having the little amount of utterances, thereby encouraging utterances. Moreover, a person who has something he/she wants to utter can move the virtual object image onto its icon, thereby expressing an intention of utterances to other users. The virtual image control unit 143 can set the virtual object image during a movement to non-display, and cause the displayed virtual object image to disappear or to suddenly appear onto the icon of a different user.

When the virtual object image 43 is to be displayed, the voice control unit 144 generates the event sound signal for reproducing a voice associated with the virtual object image 43. The event sound signal is, for example, transmitted to the user terminal 20 of a user having an icon in which the virtual object image 43 is displayed. In the example of FIG. 4, only the user FF can listen to an event sound associated with the virtual object image 43.

In addition, when an operation to move the virtual object image 43 is performed, the event sound may be changed. As mentioned above, when an operation of moving the virtual object image 43 of the “cat” from above the icon 42 of the user FF onto the icon 42 of the user CC is performed, for example, it is possible to let the user FF who is a movement source hear a voice such as a crying voice of a cat that gradually becomes smaller as if the cat is going away. In addition, it is possible to let the user CC who is a movement destination hear a voice such as a crying voice of a cat that gradually becomes larger as if the cat is approaching.

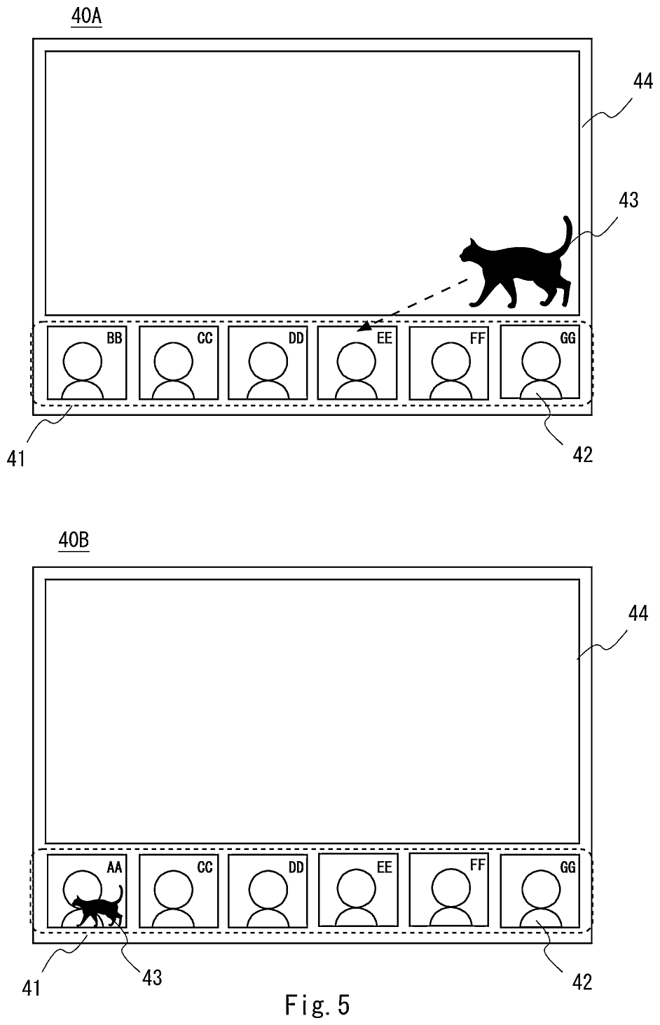

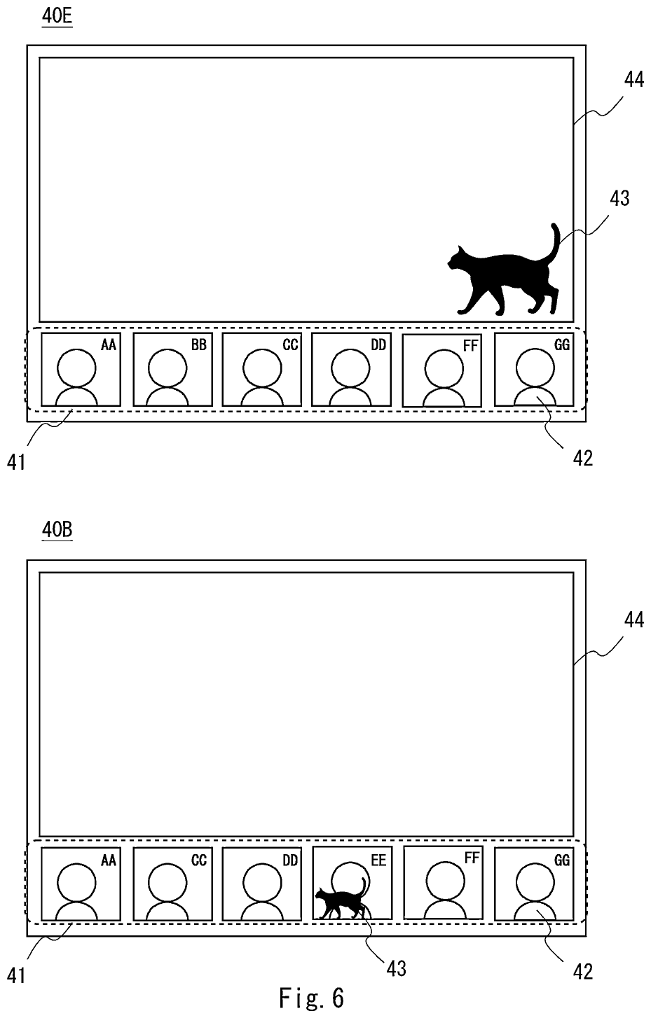

With reference to FIGS. 5 and 6, other examples of the display screen 40 displayed on the display unit 24 of the user terminal 20 will be described. In the examples illustrated in FIGS. 5 and 6, it is assumed that seven users each indicated by initials AA to GG participate in the online meeting.

The upper section of FIG. 5 shows a display screen 40A which is visually recognized by the user AA, and the lower section shows a display screen 40B visually recognized by the user BB. In addition, the upper section of FIG. 6 shows a display screen 40E visually recognized by the user EE, and the lower section shows the display screen 40B visually recognized by the user BB. If there is no need to distinguish display screens visually recognized by each user, the display screen is described as the display screen 40.

In the examples illustrated in FIGS. 5 and 6, it is assumed that an example of sharing a display screen of the user terminal 20 of the user AA is shown. Every display screen 40 of each user terminal 20 includes the icon display area 41 and a main display area 44. In the main display area 44, information relating to the online meeting such as a moving image of the user AA who will become a speaker in the online meeting and document materials is displayed. That is to say, the main display areas 44 visually recognized by each user are the same.

In the icon display area 41, a list of icons of other users is displayed. That is to say, the icon display areas 41 visually recognized by each user are different from one another in that an icon of himself/herself is not shown. When referring to the upper section of FIG. 5, in the icon display area 41 of the display screen 40A, icons of six users excluding the user AA are displayed. In addition, in the icon display area 41 of the display screen 40B, icons of six users excluding the user BB are displayed.

On the display screen 40A visually recognized by the user AA, the virtual object image 43 of the “cat” is displayed in the main display area 44. On the other hand, on the display screen 40B of other users excluding the user AA, the virtual object image 43 of the “cat” is displayed on the icon of the user AA in the icon display area 41. In this manner, the users other than the user AA can recognize that the virtual object image 43 of the “cat” is displayed in the main display area 44 of the user AA.

The virtual image control unit 143 can move the virtual object image 43 in accordance with an operation of a user for which the virtual object image 43 is displayed in the main display area 44. For example, it is assumed that the user AA uses a mouse provided for the user terminal 20 he/she is using to perform an operation of dragging and dropping the virtual object image 43 of the “cat” within the main display area 44 toward the icon of the user EE in the icon display area 41, as illustrated with an arrow of a broken line in FIG. 5.

In accordance with the operation, the virtual image control unit 143 can perform control such that the virtual object image 43 of the “cat” goes out from the main display area 44 of the user AA and enters the main display area 44 of the user EE. In this manner, the display screen 40E visually recognized by the user EE will become a state shown in the upper section of FIG. 6. In addition, on a display screen visually recognized by a user other than the user EE (for example, the display screen 40B visually recognized by the user BB), as shown in the lower section of FIG. 6, the virtual object image of the “cat” is displayed on the icon of the user EE in the icon display area 41.

The voice control unit 144 may generate the event sound signal for reproducing a voice associated with the virtual object image 43. This event sound signal is, for example, transmitted only to the user terminal 20 in which the virtual object image 43 is displayed in the main display area 44. In the example of FIG. 5, only the user AA, and in the example of FIG. 6, only the user EE, can listen to an event sound associated with the virtual object image 43.

In addition, as mentioned above, the event sound reproduced in each user terminal 20 of the user AA and the user EE may be changed according to a movement of the virtual object image of the “cat”. For example, it is possible to configure such that, when the virtual object image 43 of the “cat” goes out from the main display area 44 of the user AA, a crying voice of a cat becomes gradually smaller, and when the virtual object image 43 of the “cat” enters the main display area 44 of the user EE, the crying voice of the cat becomes gradually larger.

The position information acquisition unit 145 acquires position information of each user terminal 20. The position information acquisition unit 145 can link the acquired position information with a user ID, and store this on the user information DB 112.

The display control unit 141 may decide an arrangement of the icon of each user in accordance with the acquired position information. For example, when performing a grid display of the icons 42 on the display screen 40, up, down, left, and right can be set as the north, the south, the west, and the east, respectively. The display control unit 141 can, on the display screen 40 in which the directions are set in such manner, arrange the icon of each user within the display screen 40 in accordance with the position information of each user terminal 20. For example, on the display screen 40, as an icon is arranged on the upper side, the user terminal 20 used by the user of this icon is positioned in the north. In addition, the display control unit 141 may, for example, arrange icons of a plurality of users on a map in accordance with the position information of the user terminal 20.

The virtual image generation unit 142 can display, on the icon of each user, a virtual image in accordance with the position information of the user terminal 20. The virtual image generation unit 142 can generate, for example, as the virtual object image, an image relating to a weather in a location of the user terminal 20 in accordance with the position information of the user terminal 20.

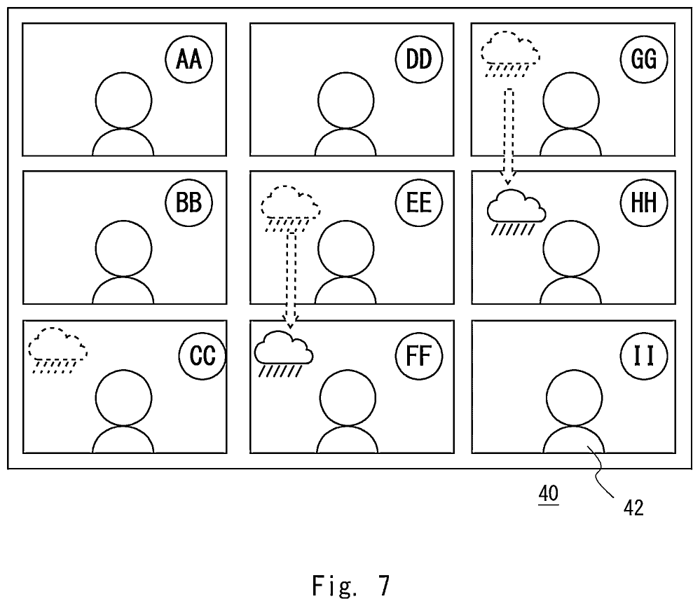

If positions of the user terminals 20 are close, there is a high probability that the weather conditions are the same. Thus, for example, the virtual image generation unit 142 can display, on the icons of the users of the user terminals 20 positioned within a predetermined range, an image relating to a common weather as the virtual object image. FIG. 7 is a diagram showing an example of displaying an image relating to a common weather on a plurality of icons. As illustrated in FIG. 7, on the display screen 40, a list of the icons 42 of nine users are displayed in a grid shape.

In FIG. 7, on the display screen 40, an image relating to a common weather (a rain symbol of a broken line) is displayed on the icons 42 of the users CC, EE, and GG. Accordingly, it can be understood that the user terminals 20 of the users CC, EE, and GG are positioned within a predetermined range. In addition, for example, the rain symbol illustrated with the broken line moves to a position of a solid line (onto the icons of the users FF, HH) over a passage of time, as illustrated with an arrow. In this manner, each user can recognize a transition of a weather in each place in which each user terminal 20 is located.

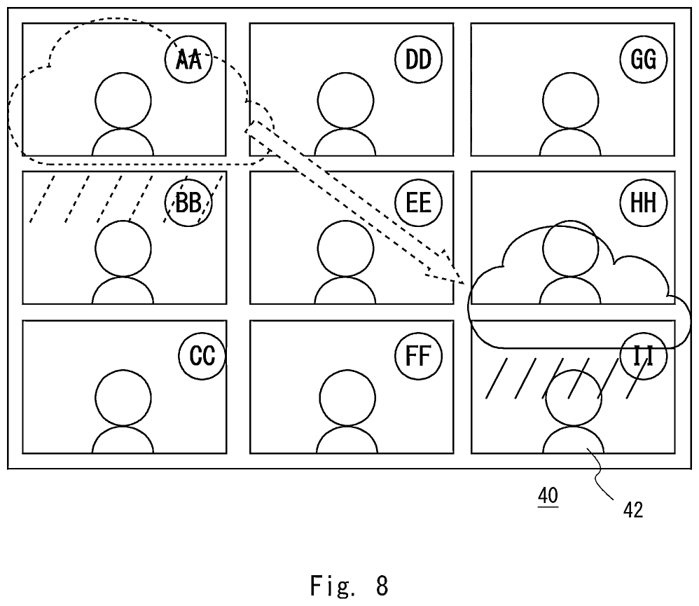

FIG. 8 is a diagram showing an example in which an image relating to one weather is displayed so as to cover a plurality of icons. As illustrated in FIG. 8, on the display screen 40, a list of the icons 42 of nine users are displayed in a grid shape. In this example, it is assumed that the icon of each user is arranged in accordance with the position information.

In FIG. 8, on the display screen 40, one rain symbol of a broken line is displayed throughout above the icons 42 of the users AA, BB, and DD. It is assumed that the rain symbol illustrated with the broken line moves to a position of a solid line (onto the icons of the users HH, II) over a passage of time, as illustrated with an arrow. In the example of FIG. 8, it can be understood that an area of the rain is moving from the northwest direction to the southeast direction. In this manner, if the icon of each user is arranged in accordance with the position information, each user can also expect a future change of the weather while looking at the display screen 40.

The virtual image generation unit 142 may generate a virtual background image in accordance with the position information. The virtual background image is an image that is synthesized as a background of each user in the icon. The virtual background image may include a tourist site, a famous place, a special product, and the like of a region in which the user terminal 20 is located. In this manner, a characteristic of a region in which each user is present can be shared by all the users. In addition, the virtual image generation unit 142 can also overlap and synthesize an image relating to a weather of a location of the user terminal 20 with the virtual background image. Furthermore, the virtual background image may be an image representing a weather.

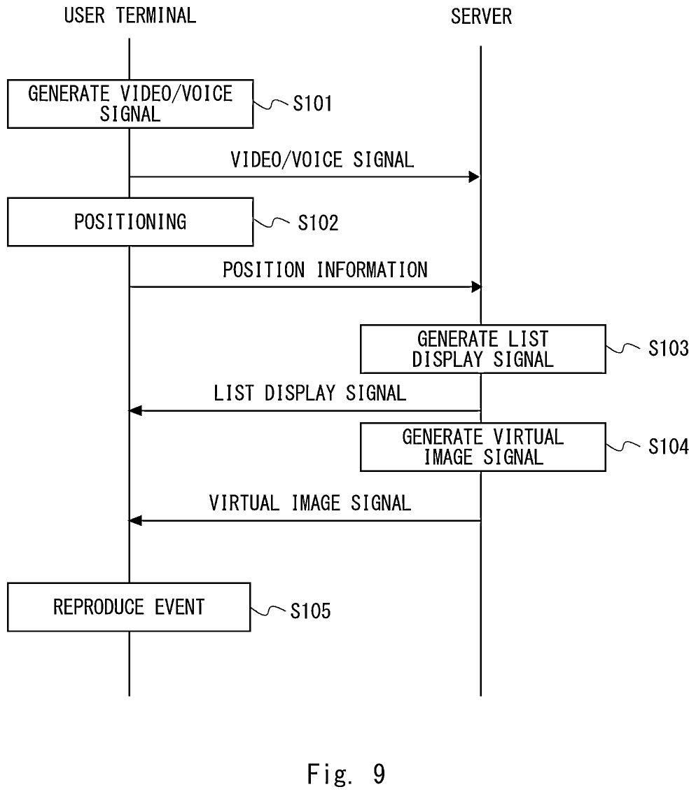

FIG. 9 is a diagram showing a flow of an information processing method by the online meeting system according to the embodiment. Firstly, the user terminal 20 generates a video/voice signal of a user and outputs this signal to the server 10 (S101). In addition, the user terminal 20 acquires position information of the user terminal 20, and outputs this position information to the server 10 (S102). The server 10 generates a list display signal for displaying a list of icons of a plurality of users participating in an online meeting in the icon display area of a display screen, and transmits this list display signal to the user terminal 20 (S103). As mentioned above, in the icon display area, the icon of each user may be aligned in accordance with the position information of the user terminal 20.

In addition, the server 10 generates a virtual image signal, which is in common in each user terminal and is to be displayed on an icon of at least one of the plurality of users (S104). As mentioned above, the server 10 may generate the virtual image signal in accordance with the position information of the user terminal 20.

A timing at which the virtual image signal is generated and an event occurs may be random, and it can be any timing such as when all of the plurality of users enter the online meeting, or when a predetermined time has passed since the start of the online meeting. By causing an event to occur after a passage of a predetermined time, the users can be encouraged to take a rest.

In addition, the occurrence timing of an event may be when utterances of participants are stagnated. In this manner, it is possible to encourage refreshment, make changes in thinking, and make the meeting lively. Furthermore, the occurrence timing of an event may be when a discussion between users is heated. In this manner, it is possible to calm the users' mind, and proceed the meeting steadily.

Whether utterances of users are stagnated or a discussion is heated may be judged by the voice recognition unit which specifies a topic included in a content of speech by a publicly-known voice recognition technique. In the case of a heated discussion, the volume of conversations usually tends to become large. Thus, the server 10 may have a function to measure the loudness of an input sound (sound volume), and judge the quantity of utterances based on the sound volume.

In addition, the occurrence timing of an event may be a timing set by each user. For example, in order to let other users know that a leaving time of the online meeting is getting close, the event occurrence timing may be set to, for example, 5 minutes before an ending time.

The user terminal 20 displays the icon display area 41 in the display unit 24. In addition, the user terminal 20 can display a virtual image on at least one icon 42 within the icon display area 41 in a superimposing manner, and reproduce an event (S105).

As described above, according to the embodiment, in an online meeting or the like conducted in a plurality of places at the same time, feelings of participants can be synchronized and tuned by reproducing a sound and a video based on a common parameter. In this manner, a sharing sense of a meeting scene can be complemented, and a lively discussion can be encouraged. In addition, an effect of introduction communication (so-called icebreaking) can be exerted by causing an event to occur at the beginning of the meeting.

According to the present disclosure, in an online meeting using a plurality of terminal apparatuses connected through a network, a sharing sense of a meeting scene can be complemented.

Although the disclosure by the present inventors has been specifically described above based on the embodiments, it is needless to say that the present disclosure is not limited to the above-described embodiments, and various alterations can be made without departing from the scope.

In terms of hardware, each functional block performing various processings described in the drawings can be constituted of a processor, a memory, or other circuits. In addition, the processings mentioned above can be realized by causing a processor to execute a program. Accordingly, these functional blocks can be realized by hardware only, software only, or in various forms by combinations thereof, and are not limited to any of these.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

It is needless to say that the system illustrated in FIG. 1 is one example, and there are various configurations in accordance with the use and the purpose. The above-described embodiments show the example in which the server 10 distributing the online meeting has the event distribution function, but the present disclosure is not limited to this. For example, the event distribution function may be realized by an application program installed in each user terminal 20. In addition, the event distribution function may be realized by a single information processing apparatus, or may be realized by a plurality of information processing apparatuses formed separately from one another.

Each constituent element of the information processing apparatus may be realized by dedicated hardware. In addition, some or all of each constituent element of each apparatus may be realized by a general-purpose or dedicated circuit, a processor, etc., or a combination thereof. These may be constituted of a single chip, or a plurality of chips connected through a bus. Some or all of each constituent element of each apparatus may be realized by a combination of the above-mentioned circuit or the like and a program. Furthermore, a Central Processing Unit (CPU), a Graphics Processing Unit (GPU), a Field-Programmable Gate Array (FPGA), a quantum processor (quantum computer control chip), or the like may be used as the processor.

In addition, if some or all of each constituent element of the information processing apparatus are realized by a plurality of apparatuses, circuits, and the like, the plurality of apparatuses, circuits, and the like may be collectedly arranged or distributedly arranged. The apparatuses, circuits, and the like realizing each constituent element may be realized in a mode in which these are each connected through a communication network such as a client-server system, a cloud computing system, or the like. Furthermore, functions of the information processing apparatus may be provided in a Software as a Service (Saas) format.

Some or all of the above-described embodiments may also be described like the following Supplementary notes, but are not limited to the following.

### (Supplementary Note A1)

An information processing apparatus comprising:
a display control unit configured to display, in an online meeting in which a plurality of users participate by using a plurality of user terminals connected through a network, an icon display area in each of the user terminals, the icon display area displaying a list of an icon of each of the users; and
a virtual image generation unit configured to display a virtual image on an icon of at least one of the plurality of users, the virtual image being in common in each of the user terminals.

### (Supplementary Note A2)

The information processing apparatus according to Supplementary note A1, wherein
the virtual image is a virtual object image, and
the information processing apparatus further comprises a virtual image control unit configured to move the virtual object image from above an icon in which the virtual object image is displayed onto a different icon, in each of the user terminals.

### (Supplementary Note A3)

The information processing apparatus according to Supplementary note A2, wherein the virtual image control unit is configured move the virtual object image such that a moving aspect of the virtual object image in each of the user terminals becomes the same.

### (Supplementary Note A4)

The information processing apparatus according to Supplementary note A2 or A3, wherein the virtual image control unit is configured to move the virtual object image in accordance with an operation of at least one of the plurality of users.

### (Supplementary Note A5)

The information processing apparatus according to Supplementary note A2, wherein
the display control unit is configured to further display, in the user terminals, a main display area in which each of the users visually recognizes information related on the online meeting, and
the virtual object image is displayed in the main display area of at least one first user terminal, and is also displayed on an icon of a first user of the first user terminal in the icon display area of the user terminals other than the first user terminal.

### (Supplementary Note A6)

The information processing apparatus according to Supplementary note A5, further comprising a voice control unit configured to reproduce, in the first user terminal in which the virtual object image is displayed in the main display area, a voice associated with the virtual object image.

### (Supplementary Note A7)

The information processing apparatus according to any one of Supplementary notes A2 to A6, further comprising a voice recognition unit configured to acquire a spoken voice of the users, specify a content of speech, and output a recognition result,

wherein the virtual image generation unit is configured to generate the virtual object image based on the recognition result.

### (Supplementary Note A8)

The information processing apparatus according to Supplementary note A1, further comprising a position information acquisition unit configured to acquire position information of the plurality of user terminals,
wherein the display control unit is configured to arrange the icon of each of the users in accordance with the position information, and
the virtual image generation unit is configured to display the virtual image in accordance with the position information on the icon of each of the users, in each of the user terminals.

### (Supplementary Note A9)

The information processing apparatus according to Supplementary note A1, further comprising a voice recognition unit configured to acquire a spoken voice of the users, specify at least either of a content of speech and a sound volume, and output a recognition result,

wherein the virtual image generation unit is configured to decide a timing of displaying the virtual image based on the recognition result.

### (Supplementary Note B1)

An information processing method for causing a computer to perform:
a processing of displaying, in an online meeting in which a plurality of users participate by using a plurality of user terminals connected through a network, an icon display area in each of the user terminals, the icon display area displaying a list of an icon of each of the users; and
a processing of displaying a virtual image on an icon of at least one of the plurality of users, the virtual image being in common in each of the user terminals.

### (Supplementary Note C1)

A program for causing a computer to perform:
a processing of displaying, in an online meeting in which a plurality of users participate by using a plurality of user terminals connected through a network, an icon display area in each of the user terminals, the icon display area displaying a list of an icon of each of the users; and
a processing of displaying a virtual image on an icon of at least one of the plurality of users, the virtual image being in common in each of the user terminals.

Some or all of the elements described in Supplementary note A2 to Supplementary note A9 dependent from Supplementary note A1 (the information processing apparatus) may be dependent also from Supplementary note B1 (the information processing method) and Supplementary note C1 (the program) as in the case of Supplementary note A2 to Supplementary note A9.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An information processing apparatus comprising:
a display control unit configured to display, in an online meeting in which a plurality of users participate by using a plurality of user terminals connected through a network, an icon display area in each of the user terminals, the icon display area displaying a list of an icon of each of the users; and
a virtual image generation unit configured to display a virtual image on an icon of at least one of the plurality of users, the virtual image being in common in each of the user terminals.

2. The information processing apparatus according to claim 1, wherein
the virtual image is a virtual object image, and
the information processing apparatus further comprises a virtual image control unit configured to move the virtual object image from above an icon in which the virtual object image is displayed onto a different icon, in each of the user terminals.

3. The information processing apparatus according to claim 2, wherein the virtual image control unit is configured to move the virtual object image in accordance with an operation of at least one of the plurality of users.

4. The information processing apparatus according to claim 2, wherein the virtual object image is an object which is recognized from a content of utterances of a user participating in the online meeting.

5. The information processing apparatus according to claim 2, further comprising a voice control unit configured to reproduce, in a user terminal of a user having an icon in which the virtual object image is displayed, a voice associated with the virtual object image.

6. The information processing apparatus according to claim 2, wherein
the display control unit is configured to further display, in the user terminals, a main display area in which each of the users visually recognizes information related on the online meeting, and
the virtual object image is displayed in the main display area of at least one first user terminal, and is also displayed on an icon of a first user of the first user terminal in the icon display area of the user terminals other than the first user terminal.

7. The information processing apparatus according to claim 6, further comprising a voice control unit configured to reproduce, in the first user terminal in which the virtual object image is displayed in the main display area, a voice associated with the virtual object image.

8. The information processing apparatus according to claim 1, wherein the virtual image generation unit is configured to display the virtual image on an icon of at least one of the plurality of users based on a situation of utterances of the users participating in the online meeting.

9. The information processing apparatus according to claim 1, further comprising a position information acquisition unit configured to acquire position information of the plurality of user terminals,
wherein the display control unit is configured to arrange the icon of each of the users in accordance with the position information, and
the virtual image generation unit is configured to display the virtual image in accordance with the position information on the icon of each of the users, in each of the user terminals.

10. An information processing method for causing a computer to perform:
a processing of displaying, in an online meeting in which a plurality of users participate by using a plurality of user terminals connected through a network, an icon display area in each of the user terminals, the icon display area displaying a list of an icon of each of the users; and
a processing of displaying a virtual image on an icon of at least one of the plurality of users, the virtual image being in common in each of the user terminals.

11. A non-transitory computer readable medium storing a program for causing a computer to perform:
a processing of displaying, in an online meeting in which a plurality of users participate by using a plurality of user terminals connected through a network, an icon display area in each of the user terminals, the icon display area displaying a list of an icon of each of the users; and
a processing of displaying a virtual image on an icon of at least one of the plurality of users, the virtual image being in common in each of the user terminals.
